(19) United States
(12) Patent Application Publication
(10) Pub. No.: US 2025/0121485 A1
(43) Pub. Date: Apr. 17, 2025

(54) Auxiliary handle for a hand-held power tool

(71) Applicant: Hilti Aktiengesellschaft, Schaan (LI)

(72) Inventors: Johannes Alfred MARDER, Feldkirch (AT); Ward BARTHOLOMEE, Aachen (DE)

(21) Appl. No.: 18/689,613

(22) PCT Filed: Sep. 26, 2022
(86) PCT No.: PCT/EP2022/076612

§ 371 Date: Mar. 6, 2024

(30) Foreign Application Priority Data
Oct. 5, 2021 (EP) 21200991.4

(51) Int. Cl. B25F 5/02

(52) U.S. Cl. CPC B25F 5/026

(57) ABSTRACT

Auxiliary handle for a hand-held power tool, the auxiliary handle having a foam core which is preferably obtained by foam injection molding. The foam core is preferably enclosed by a supporting shell. The supporting shell is preferably enclosed by a soft component layer.

The present invention relates to an auxiliary handle for a hand-held power tool and to a method for producing an auxiliary handle for a hand-held power tool. Auxiliary handles for hand-held power tools are generally known from the prior art. An auxiliary handle is to be understood in particular as a handle that can be releasably attached to a hand-held power tool and which in particular is not a handle that is integral with a hand-held power tool housing.

### BACKGROUND

EP 3 233 384 B1 discloses an auxiliary handle for a hand-held power tool having a frame-shaped handle which has a handle bar for a user to grip, a transverse bar and two flanks which connect the handle bar to the transverse bar. The frame-shaped handle has a monolithic, continuous main body that forms the handle bar, transverse bar, and two solid-state joints. The main body is preferably injection molded from a rigid plastics material. The plastics material is, for example, polyamide.

DE 21 2016 000 222 U1 describes a photographic equipment support bar having an inner core and a casing, the casing embedding the inner core or a portion of the inner core so as to surround it. The casing is formed on the inner core by foam injection molding or overmolding.

### SUMMARY OF THE INVENTION

It is an object of the present invention to provide an auxiliary handle having a simple and inexpensive design.

The present invention provides an auxiliary handle having a foam core. It has been found to be advantageous if the foam core is obtained by means of foam injection molding.

The invention includes the knowledge that in the case of auxiliary handles of the prior art which are equipped with a typically thin-walled main body made of plastics injection molding, even this main body can lead to an unfavorable accumulation of mass of a soft component, by means of which the main body is in turn to be overmolded. This can lead to long cycle times and to a very high proportion of soft components, which disadvantageously results in high production costs.

The foam core according to the invention creates the basis for a free design of the mechanically relevant inner contour of a supporting shell to be applied to the foam core, without being restricted by the design of a visible outer contour of the supporting shell. By foaming the foam core-which in principle represents a “lost core”—the use of material can be optimized. The free choice of material for the foam core means that the weight and costs can be optimized, or additional boundary conditions can be taken into account, such as the use of recycled plastics materials that cannot be used as the shell material for mechanical or optical reasons. By using the foam core, an outwardly closed contour can be produced, which can be freely designed within wide limits in terms of ergonomic, haptic and mechanical properties.

In a particularly preferred embodiment, the foam core is at least partially enclosed by a supporting shell. It has been found to be advantageous if the foam core is completely enclosed by the supporting shell.

In a further particularly preferred embodiment, the supporting shell is at least partially enclosed by a soft component layer. It has been found to be advantageous if a predominant surface portion of the supporting shell is enclosed by the soft component layer.

It has been found to be advantageous if the foam core is provided as an insert and/or the supporting shell is obtained by overmolding the insert. In a further particularly preferred embodiment, the supporting shell and the soft component layer can be obtained by 2K injection molding. In this case the foam core is provided in particular as an insert.

In a particularly preferred embodiment, the foam core and the supporting shell have the same material or consist of the same material. This offers the advantage of a possible connection between the foam core and the supporting shell. It has been found to be advantageous if the foam core and/or the supporting shell consist of a plastics material or contain plastics material. It has also been found to be advantageous if the plastics material is a glass-fiber-reinforced plastics material, in particular a glass-fiber-reinforced polyamide, for example PA6GF30. The foam core can consist of a recycled plastics material or have such a material.

In a further particularly preferred embodiment, the soft component layer consists of a thermoplastic elastomer or has such an elastomer. In a further particularly preferred embodiment, the foam core is obtained by physical and/or chemical foaming.

It has been found to be advantageous if the foam core has a degree of foaming greater than 30 percent and/or a degree of foaming less than 60 percent. It has also been found to be advantageous if the supporting shell consists of an unfoamed plastics material. The supporting shell can have a degree of foaming of less than 10 percent, preferably less than 5 percent. It has been found to be advantageous if the foam core accounts for at least 50 percent, preferably at least 75 percent, of the total volume of the auxiliary handle.

The present invention also provides a hand-held power tool, in particular an electric hand-held power tool having an auxiliary handle of the type described above.

The present invention also provides a method for producing an auxiliary handle for a hand-held power tool, in which a foam core and a supporting shell at least partially surrounding the foam core are provided. It has been found to be advantageous if the foam core is provided as an insert and the supporting shell is provided after the foam core has been provided. In a particularly preferred embodiment, the supporting shell is obtained by overmolding the insert. It has been found to be advantageous if the supporting shell is partially enclosed with a soft component layer within the scope of the method, preferably by means of overmolding. The supporting shell and the soft component layer can be provided by means of a 2K injection molding process. The method can further be developed in a corresponding manner by the features used in relation to the device.

Further advantages can be found in the following description of the drawings. Particularly preferable embodiments of the present invention are shown in the drawings. The drawings, the description and the claims contain numerous features in combination. A person skilled in the art will expediently also consider the features individually and combine them to form meaningful further combinations.

### BRIEF DESCRIPTION OF THE DRAWINGS

In the drawings, identical and equivalent components are provided with the same reference signs. In the drawings:

FIG. 1 shows a preferred embodiment of an auxiliary handle;

FIG. 2 is a section through the auxiliary handle of FIG. 1; and

FIG. 3 shows a method for producing an auxiliary handle.

### DETAILED DESCRIPTION

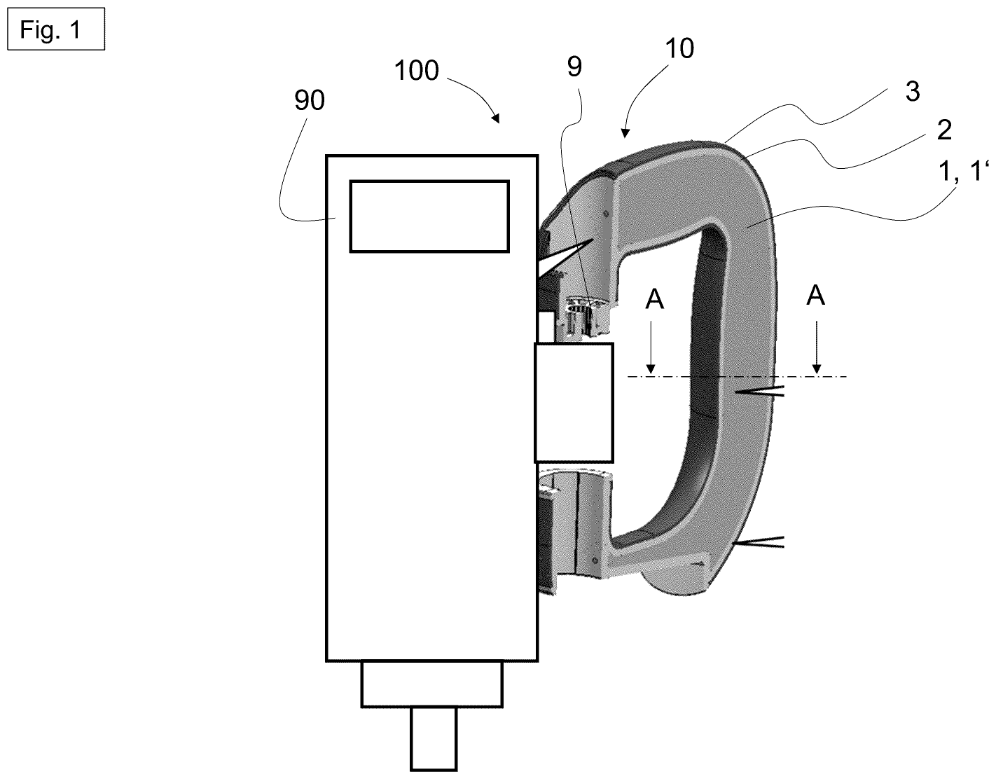

FIG. 1 shows—in a highly schematic representation—an electric hand-held power tool 100 having an integrated housing handle 90. The electric hand-held power tool 100 is also equipped with an auxiliary handle 10, which has a foam core 1 according to the invention. The foam core 1 consists, for example, of a glass-fiber-reinforced polyamide PA6GF30, which is a recycling material. The foam core 1 was obtained by physical foaming and has, for example, a degree of foaming of 40 percent.

As can be seen from FIG. 1, the foam core 1 is completely enclosed by a supporting shell 2. The foam core 1 is provided as an insert 1′ and the supporting shell 2 was obtained by overmolding the insert 1′. The use of the foam core 1 provided as an insert 1′ as a “lost core” allows a significant weight reduction by foaming the material based on the identical volume with compact material, and the use of inferior and inexpensive recycling material. By using the insert 1′, an outwardly closed contour can be produced, which can be freely designed within wide limits in terms of ergonomic, haptic and mechanical properties.

The foam core 1 and the supporting shell 2 have the same material, i.e. in the present case the glass-fiber-reinforced polyamide PA6GF30. The supporting shell 2 consists of unfoamed material.

The supporting shell 2 is—with the exception of a housing connection region 9 of the auxiliary handle 10—completely enclosed by a soft component layer 3, which is used for user comfort. The soft component layer consists, for example, of a thermoplastic elastomer. The supporting shell 2 and the soft component layer 3 were obtained, for example, by 2K injection molding.

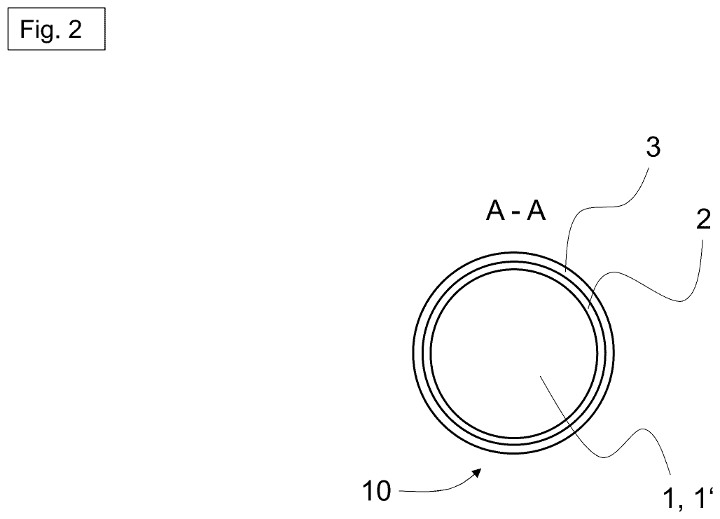

FIG. 2 is a section through the auxiliary handle 10 along section line A-A in FIG. 1. As can be seen from FIG. 2, the homogeneously formed foam core 1 accounts for the majority—in the present example more than 80 percent—of the cross-sectional area of the auxiliary handle 10. Overall, the foam core 1 accounts for, for example, at least 75 percent of a total volume of the auxiliary handle 10.

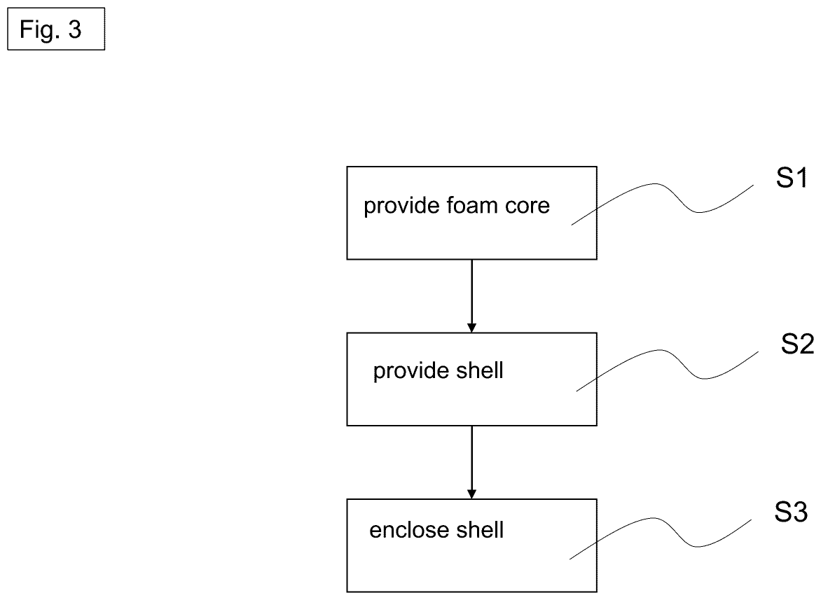

A method for producing an auxiliary handle for a hand-held power tool, in particular the auxiliary handle 10 of FIG. 1, is shown in FIG. 3. In a first step S1, a foam core is provided as an insert. This is achieved by means of foam injection molding a glass-fiber-reinforced polyamide, for example having a degree of foaming of 40 percent.

In a subsequent step S2, a supporting shell is provided, which completely surrounds the foam core. To position the insert, spacers can be integrated into the geometry, which define the wall thickness of the structurally load-bearing supporting shell when overmolded with the material of the supporting shell.

In a subsequent step S3, the supporting shell is at least partially enclosed with a soft component layer. Step S2 of providing the supporting shell and step S3 of providing the soft component layer are carried out, for example, by means of a 2K injection molding process.

### LIST OF REFERENCE SIGNS

1 Foam core
1′ Insert
2 Supporting shell
3 Soft component layer
9 Housing connection region
10 Auxiliary handle
90 Housing handle
100 Hand-held power tool
S1 . . . S3 Method steps

What is claimed is:

1 to 15 (canceled)

16. An auxiliary handle for a hand-held power tool, the auxiliary handle comprising: a foam core.

17. The auxiliary handle as recited in claim 16 wherein the foam core is a foam injection molded core.

18. The auxiliary handle as recited in claim 16 further comprising a supporting shell at least partially enclosing the foam core.

19. The auxiliary handle as recited in claim 18 further comprising a soft component layer at least partially enclosing the supporting shell.

20. The auxiliary handle as recited in claim 18 wherein the foam core is an insert and the supporting shell overmolds the insert.

21. The auxiliary handle as recited in claim 19 wherein the supporting shell and the soft component layer are 2K injection molded.

22. The auxiliary handle as recited in claim 18 wherein the foam core and the supporting shell include the same material or consist of the same material.

23. The auxiliary handle as recited in claim 22 wherein the foam core and the supporting shell consist of the same material.

24. The auxiliary handle as recited in claim 22 wherein the same material is a glass-fiber-reinforced polyamide.

25. The auxiliary handle as recited in claim 19 wherein the soft component layer consists of a thermoplastic elastomer.

26. The auxiliary handle as recited in claim 19 wherein the soft component layer includes a thermoplastic elastomer.

27. The auxiliary handle as recited in claim 16 wherein the foam core is physically or chemically foamed.

28. The auxiliary handle as recited in claim 16 wherein the foam core has a degree of foaming between 30 percent and 60 percent.

29. The auxiliary handle as recited in claim 16 wherein the foam core accounts for at least 50 percent of a total volume of the auxiliary handle.

30. The auxiliary handle as recited in claim 29 wherein the foam core accounts for at least 75 percent of the total volume of the auxiliary handle.

31. A hand-held power tool comprising the auxiliary handle as recited in claim 16.

32. A method for producing an auxiliary handle for a hand-held power tool, comprising the steps of:
(S1) providing a foam core, and
(S2) providing a supporting shell that at least partially surrounds the foam core.

33. The method as recited in claim 32 further comprising the step of:
(S3) at least partially enclosing the supporting shell with a soft component layer.

34. The method as recited in claim 33 wherein the foam core is provided as an insert and the step (S2) of providing the supporting shell takes place after the step (S1) of providing the foam core, wherein the supporting shell is obtained by overmolding the insert.

35. The method as recited in claim 33 wherein the step (S2) of providing the supporting shell and the step (S3) of providing the soft component layer are carried out via a 2K injection molding process.
